(19) United States
(12) Patent Application Publication
(10) Pub. No.: US 2015/0329260 A1
(43) Pub. Date: Nov. 19, 2015

(54) METHODS AND SYSTEMS FOR ACCESSING INVENTORY USING SMART CONTAINERS

(71) Applicant: Narendra Singh, Santa Clara, CA (US)

(72) Inventor: Narendra Singh, Santa Clara, CA (US)

(21) Appl. No.: 14/281,819

(22) Filed: May 19, 2014

(51) Int. Cl. B65D 79/00; G06Q 10/08; H04L 29/06

(52) U.S. Cl. CPC B65D 79/00; H04L 67/42; G06Q 10/087

(57) ABSTRACT

Systems and methods are presented for accessing inventory using smart containers. In some embodiments, a computer-implemented method is presented. The method may include accessing information associated with at least one smart container, the information including an amount of a consumable good within the at least one smart container. The method may also include accessing at least one consumption criterion based on a user input, determining whether the at least one consumption criterion is satisfied based on the information associated with the at least one smart container, and displaying an output based on the determination.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, eBay Inc. All Rights Reserved.

### TECHNICAL FIELD

The subject matter disclosed herein generally relates to accessing consumer goods. In some example embodiments, the present disclosures relate to systems and methods for accessing inventory using smart containers.

### BRIEF DESCRIPTION OF THE DRAWINGS

Some embodiments are illustrated by way of example and not limitation in the figures of the accompanying drawings.

FIG. 1 is a mobile device suitable for accessing information associated with one or smart containers, according to some example embodiments.

FIG. 2 is a network architecture suitable for storing information associated with one or more smart containers, and for processing the information associated with the one or more smart containers, according to some example embodiments.

FIG. 3 is an illustration of example smart containers coupled to a mobile device, used in some example embodiments.

FIG. 4 is an example query based on information from smart containers, according to some example embodiments.

FIG. 5 illustrates an another example query, according to some example embodiments.

FIG. 6 illustrates an example response to a query, used in some example embodiments.

FIG. 7 illustrates another example response to a query, used in some example embodiments.

FIG. 8 is a flowchart illustrating example operations for accessing inventory using smart containers, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods, apparatuses and systems are presented for accessing inventory using smart containers. In some example embodiments, smart containers may house or hold consumer goods and be configured to measure or estimate a current amount or quantity of the good. In some example embodiments, the smart containers may be connected wirelessly to a centralized application or program, such as an app on a mobile device. In some example embodiments, the application may include a user interface and be configured to provide information as to whether the combination of the amount of goods in the smart containers satisfies some specified user criterion, based on the estimated or measured amounts of the goods from the smart containers. Examples of user criteria may include whether a certain recipe or constructed product can be created based on the amounts of goods in the containers, and what types of recipes or constructed products and how much could be created based on the current amounts of goods in the containers. These and other details will be discussed below, in accordance with the figures.

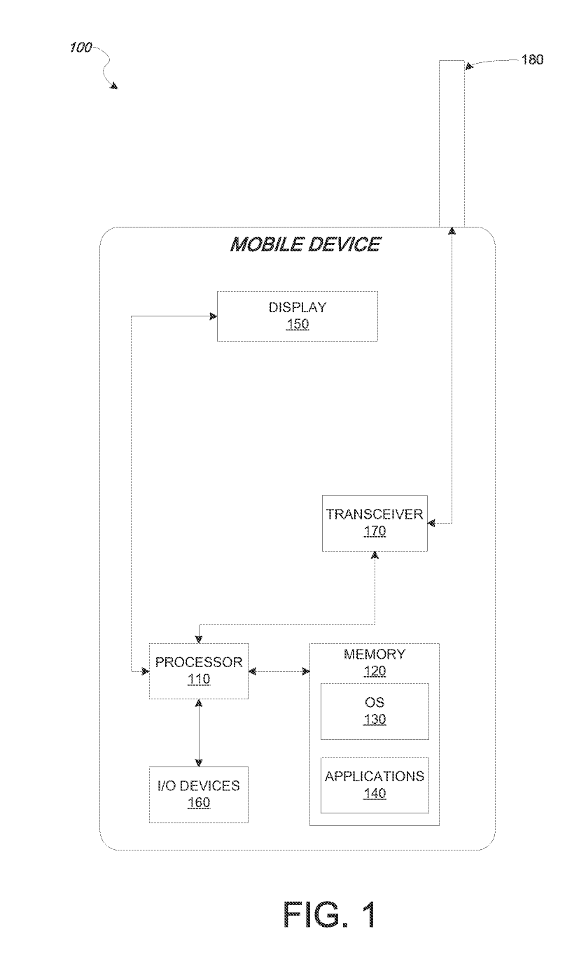

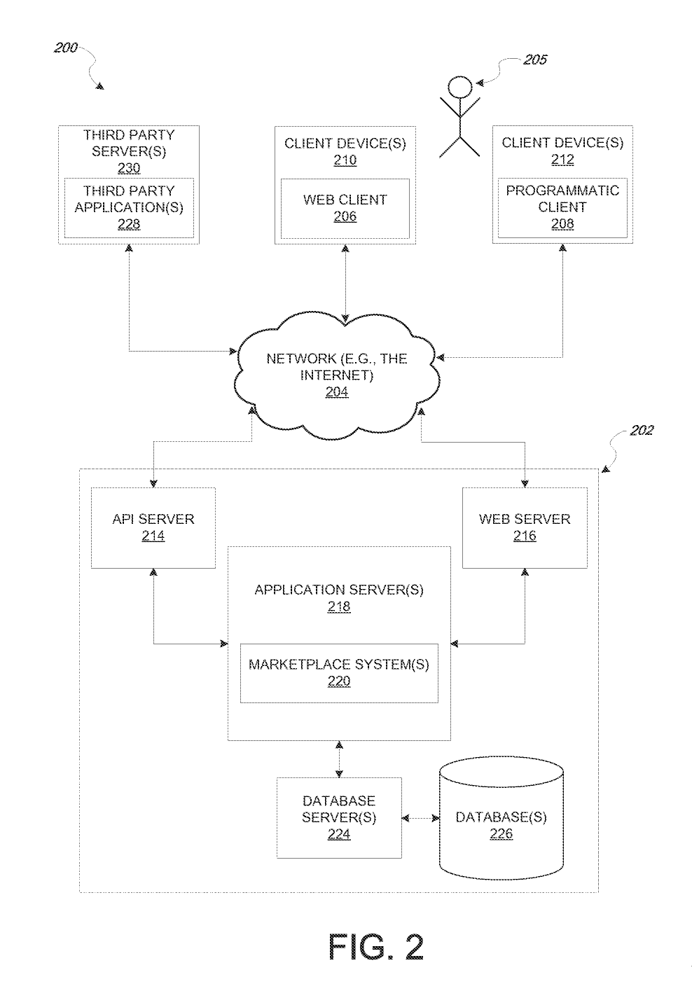

Referring to FIG. 1, a block diagram illustrating a mobile device 100 is presented, according to some example embodiments. The mobile device 100 may be configured to access measurements or readings from various smart containers via wireless methods, such as Wifi or Bluetooth®. The readings or measurements from the smart containers may include, for example, measured or estimated amounts of a good kept in a smart container. The mobile device 100 may be configured to display these amounts on display 150, for example, in a user interface (UI) generated from an application running on mobile device 100. The mobile device 100 may include a processor 110. The processor 110 may be any of a variety of different types of commercially available processors suitable for mobile devices (e.g., an XScale architecture microprocessor, a Microprocessor without Interlocked Pipeline Stages (MIPS) architecture processor, or another type of processor). The processor 110 may be configured to run the application displayed in display 150, as well as access the measurements or readings from the smart containers and process this information in accordance with aspects of the present disclosure. A memory 120, such as a random access memory (RAM), a Flash memory, or other type of memory, is typically accessible to the processor 110. The memory 120 may be adapted to store an operating system (OS) 130, as well as application programs 140, such as a mobile application for displaying the readings or measurements from the smart containers and for determining whether the amounts of goods in the smart containers satisfies any number of specified user criteria, which will be discussed in more detail below. The processor 110 may be coupled, either directly or via appropriate intermediary hardware, to a display 150 and to one or more input/output (I/0) devices 160, such as a keypad, a touch panel sensor, a microphone, and the like. Similarly, in some embodiments, the processor 110 may be coupled to a transceiver 170 that interfaces with an antenna 180. The transceiver 170 may be configured to both transmit and receive cellular network signals, wireless data signals, or other types of signals via the antenna 180, depending on the nature of the mobile device 100. Additionally, transceiver 170 may receive readings or measurements from various smart containers, and may also transmit signals requesting information from the smart containers. In this manner, a connection with a network such as network 204 of FIG. 2, discussed more below, may be established.

Referring to FIG. 2, a high-level client-server-based network architecture 200 is shown, according to some example embodiments. The network architecture 200 may include systems, applications, modules, and/or other means for utilizing aspects of the present disclosures, as may be apparent to those with skill in the art. For example, the network architecture 200 may include means for accessing readings or measurements from one or more smart containers, and for determining whether the amounts of goods in the smart containers satisfies various user specified criteria, according to aspects of the present disclosure. Example means for accessing readings or measurements from smart containers can include a receiver configured to receive wireless signals from the smart containers, the wireless signals including information about the amounts in the smart containers and other types of information, described more below. The receiver could be coupled to one or more servers in architecture 202, e.g., API server 214, or web server 216. As another example, the network architecture 200 may also be configured to operate an application configured to perform these functions, and may also be configured to display this information in a UI that is accessible to the user through various means, such as in a mobile device or on a computer connected to network architecture 200. In other cases, the network architecture 200 may be configured to transmit this information to various client devices. In some example embodiments, a networked system 202 may facilitate a network-based marketplace system 220, providing server-side functionality via a network 204 (e.g., the Internet or wide area network (WAN)) to one or more client devices 210 and 212. FIG. 2 illustrates, for example, a web client 206 (e.g., a browser, such as the Internet Explorer® browser developed by Microsoft®), and a programmatic client 208 executing on respective client devices 210 and 212. The network-based marketplace system 220 may include a website or other central repository for storing and displaying the measurements or readings from the various smart containers.

Examples of client devices 210 and 212 may include, but are not limited to, a mobile phone, smart container, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 202. Example client devices 210 and 212 may be consistent with the mobile device 100 described in FIG. 1. In some embodiments, the client device 210 may comprise a display module (not shown) configured to display information (e.g., in the form of user interfaces) and images. In further embodiments, the client device 210 may comprise one or more of touch screens, accelerometers, gyroscopes, cameras, microphones, global positioning system (GPS) devices, and so forth. In some example embodiments, a client device 210 can be a smart container configured to transmit and receive information to and from the networked system 202. For example, the smart container can transmit readings and measurements about its contents via the network 204, the information of which can be stored in a database 226. Another client device 212, such as a mobile device 100, can then access the smart container readings from database 226 through the network 204. For example, a user 205 can access readings and measurements of one of his smart containers, located at home, while at work through his mobile device, based on example architecture 200. In other cases, information can be transmitted to a client device 210, such as a smart container, through the network 204. Example information could include recall warnings on certain types of ingredients or food, updated recipes, or updated measurement conversions. In some examples embodiments, the networked system 202 is a network-based marketplace that responds to requests for product listings, publishes publications comprising item listings of products available on the network-based marketplace, and manages payments for these marketplace transactions. The product listings may include one or more images of the one or more various goods stored in any of the smart containers. One or more users 205 may be a person, a machine, or other means of interacting with client devices 210 and 212. In embodiments, the user 205 is not part of the network architecture 200, but may interact with the network architecture 200 via client devices 210 and 212 or another means.

An application program interface (API) server 214 and a web server 216 may be coupled to, and provide programmatic and web interfaces respectively to, one or more application servers 218. The application servers 218 may host one or more marketplace systems 220, which may comprise one or more modules or applications and which may be embodied as hardware, software, firmware, or any combination thereof. The application servers 218 are, in turn, shown to be coupled to one or more database servers 224 that facilitate access to one or more information storage repositories or database(s) 226. In some example embodiments, the databases 226 are storage devices that store information to be posted (e.g., publications or listings, images of products, etc.) to the marketplace system(s) 220. The databases 226 may also store digital goods information in accordance with example embodiments.

The marketplace system(s) 220 may provide a number of marketplace functions and services to users 205 that access the networked system 202. For example, after determining the amounts of goods stored in the smart containers, an application may offer to direct the user to purchase some of the goods via marketplace system(s) 220. The application may reside in a client device 210 or 212, or be downloaded at a client device 210 from application 218, for example. The application may also have streamlined or automatic access to allow goods to be purchased via marketplace system(s) 220, enabling the user 205 to more easily make desired purchases. While the marketplace system(s) 220 is shown in FIG. 2 to form part of the networked system 202, it will be appreciated that, in alternative embodiments, the marketplace system(s) 220 may form part of a payment service that is separate and distinct from the networked system 202.

Further, while the client-server-based network architecture 200 shown in FIG. 2 employs a client-server architecture, the present inventive subject matter is of course not limited to such an architecture, and may equally well find application in a distributed, or peer-to-peer, architecture system, for example. The various marketplace system(s) 220 may also be implemented as standalone software programs, which do not necessarily have networking capabilities.

The web client 206 accesses the various marketplace system(s) 220 via the web interface supported by the web server 216. Similarly, the programmatic client 208 accesses the various services and functions provided by the marketplace system(s) 220 via the programmatic interface provided by the API server 214. The programmatic client 208 may, for example, be a seller application (e.g., the Turbo Lister application developed by eBay® Inc.) to enable sellers to author and manage listings on the networked system 202 in an off-line manner, and to perform batch-mode communications between the programmatic client 208 and the networked system 202.

Additionally, a third party application(s) 228, executing on a third party server(s) 230, is shown as having programmatic access to the networked system 202 via the programmatic interface provided by the API server 214. For example, the third party application 228, utilizing information retrieved from the networked system 202, may support one or more features or functions on a website hosted by the third party. The third party website may, for example, provide one or more promotional, marketplace, or payment functions that are supported by the relevant applications of the networked system 202. The third party server 230 may help proliferate the display of examples of functioning webpages based on what types of goods are being stored in the smart containers and according to the present disclosures through, for example, advertising an application used to facilitate this process.

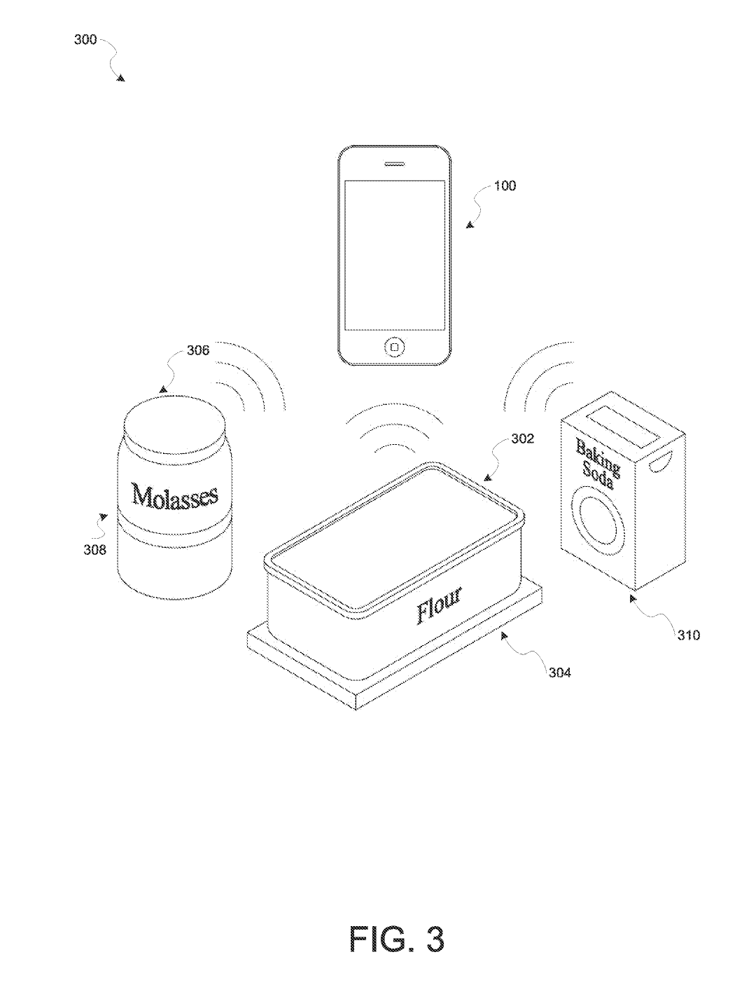

Referring to FIG. 3, illustration 300 shows various examples of smart containers storing different types of goods, according to some example embodiments. For example, container 302 may be an ordinary container, but may be considered a smart container for purposes of the present disclosure because the container 302 resides on top of a device 304 configured to estimate the amount of a good based on measuring the weight of the container 302. For example, the device 304 can be calibrated to factor out the weight of the container 302, and the remaining weight measurement may represent the weight of the goods in the container 302. Knowing the weight of the amount of the good in the container 302 may allow for a conversion to an estimated amount of the good expressed in a different form. For example, if the container 302 contained flour, the weight of the flour can be converted to an estimated mass or size, e.g. ounces or cups, based on known conversions between the weight of flour to a corresponding mass or size. Any of these readings, e.g., weight, mass, size, etc., can be recorded and stored in the container 302, according to some example embodiments. In some cases, these readings can also be transmitted via wireless means to another device, such as mobile device 100 or networked system 202. In addition, container 302 may also be configured to send alerts about the quantity or quality of the stored good, which will be discussed in more detail, below.

As another example of a smart container, jar 306 may be an ordinary jar with a sensor 308 attached to it. In other cases, jar 306 may be a jar with the sensor 308 already built in. The sensor 308 may be configured to measure the amount of a good stored in jar 306 based on determining a level of the amount of the good in the jar 306. For example, the sensor 308 may include a laser that, if able to be received on the other side of the jar 306 by a corresponding sensor, indicates the amount of goods has fallen below that level. Knowing the dimensions of the jar 306 can then allow for computing an estimated volume of jar 306 and subsequently, computing an estimated volume of the amount of goods remaining in the jar 306. The volume of the good can be converted to an estimated mass or size, e.g. ounces or cups, based on known conversions between the volume of the good to a corresponding mass or size. For example, jar 306 may store molasses, which may have a known mass or size per volume ratio.

As another example of a smart container, container 310 may already contain one or more sensors or other devices configured to measure or estimate the amount of a good remaining in the container 310. The container 310 may be purchased with the one or more sensors already built in. The sensors may be similar in function to device 304 or sensor 308, as examples. As another example, the container 310 may include a sensor configured to measure how much of the good is poured out of the container 310, and estimate the remaining amount based on how much was poured out. Similarly, as another example, a smart container may include an ordinary jar, but with a special cap or lid configured to monitor when contents in the jar are removed or poured out. As yet another example, a container that includes multiple bins or compartments can be configured to detect when the contents in a bin or compartment has been removed, and adjust a count of the contents accordingly. Examples of this type can include egg containers, shelf space, ice cube bins, vitamin trays, and the like.

Other examples of smart containers are certainly possible and may be apparent to those with skill in the art. For example, other means for monitoring and measuring the contents of a container are possible, and embodiments are not so limited.

Still referring to FIG. 3, the smart containers may be interconnected to a centralized program capable of providing information that might not be otherwise discernable but for having access to the readings and measurements of the smart containers. For example, by knowing the amounts or at least estimated amounts of the goods in various smart containers, a program may be able to determine how the goods may be combined to create or build other types of goods, and by how much. For example, with a known or at least estimated amount of flour, sugar, chocolate chips, and perhaps a few other ingredients, like eggs and butter, a program can compute how many chocolate chip cookies could be baked. For example, an application operating such a program, such as an example application running on mobile device 100 according to some example embodiments, can access recipes for chocolate chip cookies, either inputted by a user, found online, or based on preprogrammed data, etc., and compute what is the limiting ingredient based on the amount of ingredients stored in the smart containers. Methods for computing the limiting ingredient may be based on a number of mathematical principles, such as, for example, operations research or linear programming. Other methods apparent to those with skill in the art are possible, and embodiments are not so limited. Similarly, an estimated quantity of a created or built good can be computed, based on the amounts of each good in the smart containers. The smart containers may be connected wirelessly to the mobile device 100, as shown, such that the readings or measurements from the smart containers may be transmitted to the mobile device 100, and may be accessed by an application on mobile device 100. In other cases, the smart containers may be wirelessly connected to a wireless network architecture, such as the architecture shown in FIG. 2. The readings or measurements from the smart containers may be stored in a centralized system or memory in the network, such as network 204, which can then be accessed by mobile device 100. In general, aspects of the present disclosures include means for a mobile device, such as mobile device 100, to access readings or measurements from the smart containers, including measurements or at least estimates of amounts of each good in the smart containers. Aspects of the present disclosure may then utilize this information in any number of combinations to determine whether a user-specified criterion can be satisfied, such as whether a certain amount of chocolate chip cookies can be baked with the present ingredients in the smart containers.

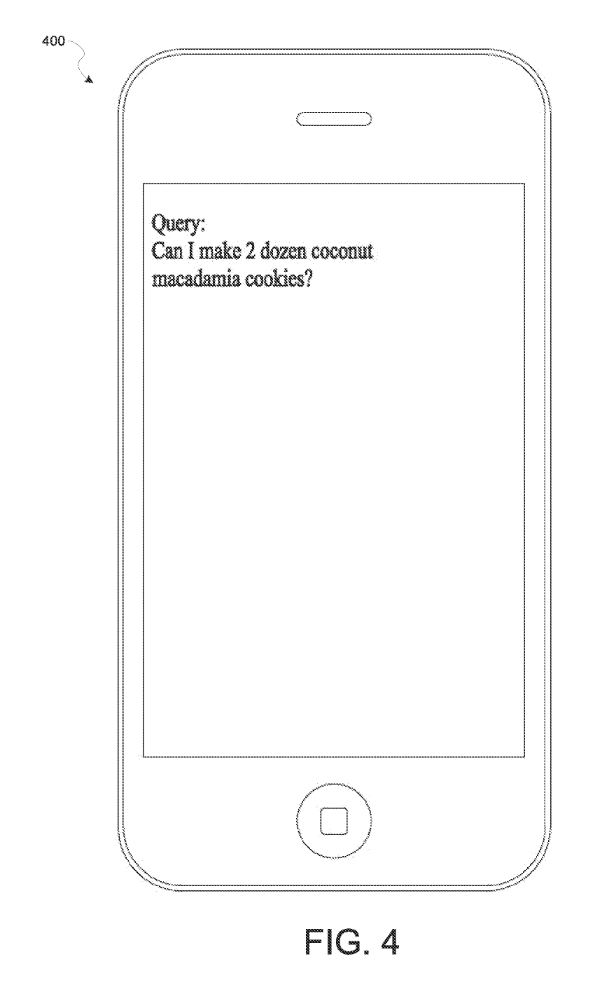

Referring to FIG. 4, user interface (UI) 400 shows an example layout on a display of the mobile device 100 for utilizing the information provided by the smart containers, according to some example embodiments. Here, a user can enter a query to an application on mobile device 100 via the UI 400. In one example, the user can request to know whether a certain recipe with a specified quantity can be baked with the present ingredients in the smart containers. In this case, the user asks: “Can I make 2 dozen coconut macadamia cookies?” An application according to aspects of the present disclosure may have access to at least one recipe for coconut macadamia cookies, as well as access to amounts of the ingredients according to the recipe, via information from the smart containers. Thus, the application may be able to compute what are the required ingredients and respective quantities for making 2 dozen coconut macadamia cookies according to a recipe, in order to determine an answer to the query. In general, a first type of query can be asked according to aspects of the present disclosure, whereby it is determined whether a specified type of product with a specified amount can be created or built.

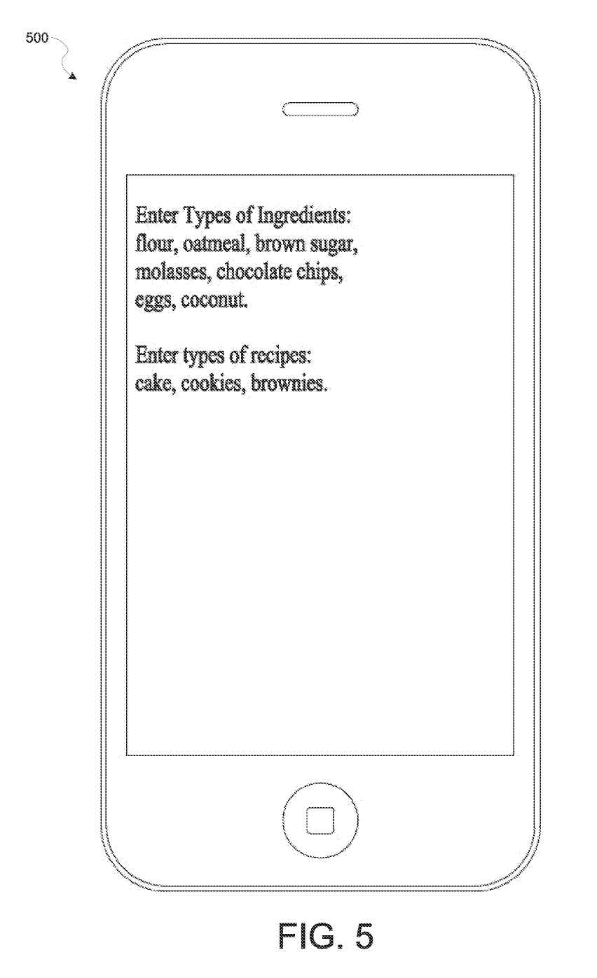

Referring to FIG. 5, in another example, the user can enter a different type of query that is more open-ended, according to some example embodiments. For example, the user may enter at the UI 500 a number of ingredients to be considered. In this case, the user enters “flour, oatmeal, brown sugar, molasses, chocolate chips, eggs, coconut.” The user can then enter multiple recipes or categories, expressing a desire to see how many of each kind of recipe or category can be made by the available ingredients listed earlier. Here, the user may enter: “cake, cookies, brownies.” The application may have at least one type of each recipe. In some cases, if a category entered by the user is not known or available by the application, the application can return an error or some other indication that a certain category or recipe is not known or understood. In other cases, if there are multiple recipes of a specified category, another screen can be displayed to allow the user to select which recipe—or even multiple recipes—to be considered. In a similar example, not shown, the contents of the containers could include parts for construction or carpentry, such as nails, screws, and pieces of wood. A user may wish to know how many chairs and/or tables can be made with the amount of materials he has. In general, a second type of query can be asked according to aspects of the present disclosure, whereby it is queried how much of each of one or more formulas or recipes can be created or built based on the amount of goods in the smart containers.

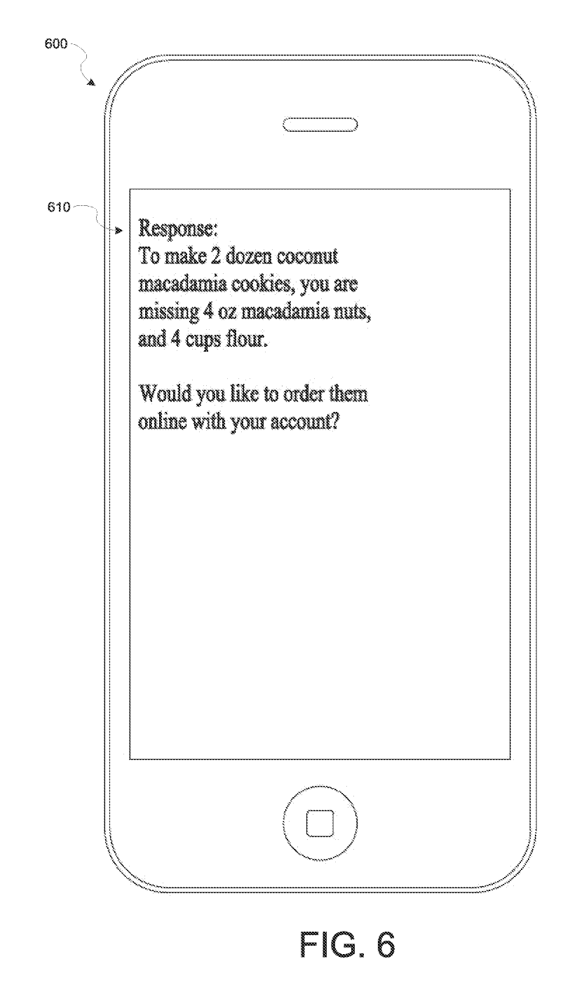

Referring to FIG. 6, an example response 610 by the application using the readings from the smart containers and additional information are shown in illustration 600, according to some example embodiments. Example response 610 may be based on the query in UI 400, which asked, “Can I make 2 dozen coconut macadamia cookies?” Here, an application according to aspects of the present disclosure may access a recipe for coconut macadamia cookies, determine what ingredients in what amounts are needed, access readings or measurements from the smart containers storing said ingredients, and determine whether there are enough ingredients available to make 2 dozen coconut macadamia cookies. In this case, an example response may be, “To make 2 dozen coconut macadamia cookies, you are missing 4 oz macadamia nuts and 4 cups flour. Would you like to order them online with your account?” As shown, the response 610 may include not only whether it is possible to satisfy the constraints specified by the user, but also what ingredients or other goods might be missing. In some example embodiments, the application may be configured to conveniently access an online store that sells the needed goods and may prompt the user, like shown in this example, whether she may want to order the needed ingredients online. The application may enable the user to conveniently and quickly order the needed ingredients with just a few additional inputs. For example, the user may affirm on the UI that she wants to order the remaining ingredients online, which may then bring up one or more preloaded order forms for the pertinent ingredients, corresponding prices, and means to pay for the order. The online store may also provide other convenient services, such as door to door delivery. In other cases, the store may provide prepackaged pick up due to the order being sent in advance through the UI. Example online stores may include eBay Local® or eBay Now®.

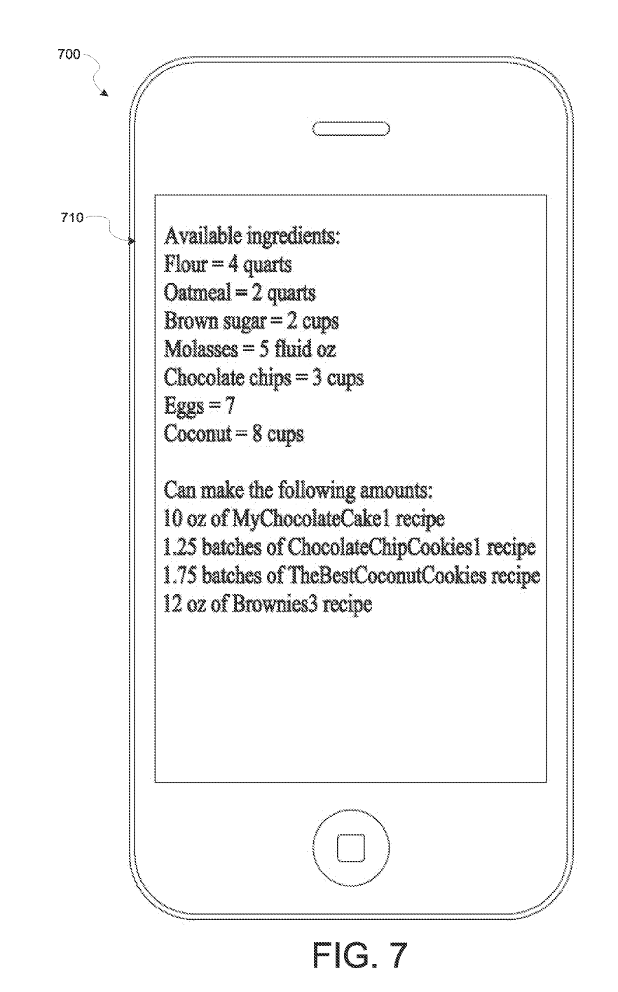

Referring to FIG. 7, in another example response according to illustration 700, response 710 may be in response to the query in FIG. 5, where the user entered as ingredients to consider, “flour, oatmeal, brown sugar, molasses, chocolate chips, eggs, coconut,” and the user entered recipes to consider, “cake, cookies, brownies.” As an example response, the application may access the readings or measurements from the smart containers, determine how much of each specified ingredient is available or estimated to be available, access a recipe for each specified dessert category, and compute how much of each recipe could be made based on the determined amounts of each specified ingredient. The results could be displayed as follows:

### “Available Ingredients:

Flour=4 quarts

Oatmeal=2 quarts

Brown Sugar=2 cups

Molasses=5 fluid oz

Chocolate chips=3 cups

Eggs=7

Coconut=8 cups

Can make the following amounts:

10 oz of MyChocolateCake1 recipe

1.25 batches of ChocolateChipCookies1 recipe

1.75 batches of TheBestCoconutCookies recipe

12 oz of Brownies3 recipe”

As shown, the application may first return a display of how much of each specified ingredient is available or estimated to be available. The application may also return how much of each recipe can be made based on those ingredients. In this case, the application displayed a particular type of recipe, such as “MyChocolateCake1,” and “ChocolateChipCookies1.” These may have been recipes entered by the user and saved under the name as shown. In addition, it may be the case that multiple recipes under one category could be made based on the specified ingredients. Thus, more than one recipe may be shown under a category. Here, two cookie recipes, namely “ChocolateChipCookies1” and “TheBestCoconutCookies” recipes are returned, with estimated amounts of each displayed in units of “batches.” In some cases, an offer to purchase more supplies can also be asked at the end of the results. For example, here, the application may ask, “Would you like to order more ingredients with your account?” Like before, a response by the user could forward the user to make purchases conveniently at an online store, and so forth.

In some example embodiments, the application can help a user determine how much of multiple recipes could be made with the available ingredients. For example, the user could specify that she wants to make one batch of chocolate chip cookies, and also inquire whether she can still make brownies, or how many brownies could be made with the remainder.

While examples in the context of baking are shown, it should be apparent that many other example contexts with different types of inventory can utilize aspects of the present disclosure. For example, smart containers could store dinner leftovers, specific kinds of meats, spices, seasonings, vegetables, and various other kinds of consumable goods. A user could then ask whether dinner or lunch could be made with particular types of food. For example, the user could ask how many sandwiches could be made with available bread, lunch meat, and cheese. As another example, the user could ask whether there is enough chicken to make a chicken dinner for 6 people that evening. If not, more could be quickly and conveniently purchased through various means, such as the connection to an online store according to some example embodiments.

Consumable items do not need to be the only goods stored in smart containers and accessed by an application according to some example embodiments. For example, instructions to build various types of woodworking projects, like cabinets, desks, and chairs, could utilize various aspects of the present disclosure as well. Smart containers in this context may store types of nails, screws, bolts, washers, or other smaller parts. A weight-detecting platform or shelf may house various sizes of wood, or a storage container with a known size can be configured to estimate the amount of wood available based on volume. In general, other containers configured to measure amounts of larger items may be consistent with the principles of the smart containers as mentioned herein, and embodiments are not so limited. Thus, various woodworking projects could be determined in analogous fashion to the baking examples as described herein. Other contexts may be readily apparent to those with skill in the art, and embodiments are not so limited.

In some example embodiments, a response to a user's query can include suggestions or recommendations for substitute ingredients or materials. For example, if the user inquired whether she could make chocolate chip oatmeal cookies with her existing ingredients found in the smart containers, an application according to aspects of the present disclosure could respond by providing a direct answer, such as the example response in FIG. 6, but also indicating that, for example, while oatmeal is not available, regular chocolate chips cookies could be made, or that she has enough rice flour to make chocolate chip rice meal cookies as a substitute. As another example, the user may not have brown sugar for a recipe that calls for brown sugar, but may have enough white sugar and/or caramel to serve as a sufficient substitute. An example response according some embodiments could suggest using available white sugar and/or caramel to substitute for the lack of brown sugar. As another example, in a carpentry context, a builder may not have wood planks of a certain size to make a table according to a certain set of instructions. However, the application according to aspects of the present disclosure may be configured to consider available wood planks of different sizes, e.g., larger wood planks, or multiple smaller wood planks, and suggest or recommend a substitution construction of the table by cutting up larger wood planks or combining multiple smaller ones. Thus, in some example embodiments, the application may also include substitute conversions for one or more ingredients or materials, and be configured to check for these substitutes and provide a response including these substitutions. In some example embodiments, the user may be able to select an option that considers substitute ingredients/materials, or can turn off this feature.

In some example embodiments, other types of sensors may be alternatively or additionally included on, in or around the smart containers. For example, nutritional information may be included, either within sensors or associated memory of the smart containers, or programmed into an application used on the mobile device 100, for example. The nutritional content of consumable goods removed from or poured out of the smart containers can then be measured or estimated, in proportion to the amount of consumable goods removed from the smart containers. In some example embodiments, an alert can be initiated if the computed nutritional value of the amount of consumable goods removed from the container exceeds some specified dietary commitment or restriction. A user may enter a specified amount of calories, carbohydrates, fats, sugars, etc., into a program according to aspects of the present disclosure. The mobile device 100 or other computer running the program may be configured to access the measured or estimated amount of consumable goods removed or poured out of the smart containers, compute the nutritional value of the consumable goods, according to some nutritional metrics, and compare it to the specified user criteria. The program can then send back a signal or alerts to the smart container, or raise an alert or alarm on the mobile device 100, if the poured out amounts of the smart container exceeds the nutritional value of the specified user criteria. Similarly, the nutritional value of consumable goods in multiple smart containers can be measured or estimated, based on similar concepts described herein, and embodiments are not so limited.

In some example embodiments, location sensors or beacons may alternatively or additionally be included in, on, or around the smart containers. The location sensors or beacons may be configured to determine a position of the smart container, based on various techniques, including GPS tracking, indoor positioning, remote-sensing, and the like. In some example embodiments, the location sensors may be able to differentiate whether the smart container is located in an unsafe location. For example, the location tracking and monitoring sensors can differentiate whether the container is at ground level or on a counter. The location tracking mechanisms of the smart containers may be sensitive enough to determine an approximate height of the smart container. The smart container may also be configured with a sensor that can either send the signal to a program to alert a user in the event the smart container has been moved to an unsafe location, or emit an alert or alarm from the sensor itself. Relatedly, in some example embodiments, a heat sensor or thermometer, etc., can also be included in, on or around the smart container, and can be configured to send an alert or alarm if it is determined that the smart container is getting too hot or too cold according to some specified temperature limits. In some example embodiments, temperature limits could be specified by the user via an input from an application on mobile device 100 that is then transmitted to the smart container. In other cases, the temperature limits could be preprogrammed by an application on mobile device 100, or even from a memory in the smart container itself, once it is specified what are the contents of the smart container. In other cases, temperature limits may be downloaded via a network, such as network 202, from a centralized agency, for example, specifying recommended temperature limits for various ingredients.

In some example embodiments, a consumer can be alerted if there is some potential health hazard or rollback to one or more of the consumable goods in the smart containers. For example, a program tied to the smart containers may receive updates on occasion, where the updates may include information learned from government bodies or other news sources about tainted goods or other problems. The program could then provide an alert or alarm on a user interface, and/or send information to the smart container containing the tainted good to raise an alarm or an alert.

In some example embodiments, the smart containers may be configured with a lock or locking mechanism to automatically close or lock the container if some condition is satisfied. For example, if a dietary restriction or commitment is exceeded or matched, then the smart containers could automatically lock so that more of the consumable good cannot be accessed. As another example, if an alert is out for a tainted consumable good, a smart container known to store that good could automatically lock until the user disposes of the good and removes the alert, for example. As another example, if it is determined that the smart container is located in an unsafe location, the smart container could also automatically lock until it is determined that the container has been moved to a safer location.

In some example embodiments, various cars or other automobiles can also be configured to practice the same or similar concepts of the smart containers as described herein. For example, cupholder spaces in a minivan could be configured to measure or estimate the amount of liquid in a container resting on top of the cupholder. For example, the minivan may be equipped with a weight sensor underneath the cupholder space, and can be connected to a program or application consistent with the descriptions herein. A user could enter into the program the type of liquid stored in the container resting on the cupholder. The program may also have access to various stores with knowledge of whether the stores sell that type of liquid or something similar, in the vicinity of the traveling minivan. Thus, aspects of the present disclosure can signal to a user whether the contents in a container are running low, and if there may be a store nearby to get a refill.

In some example embodiments, aspects of the present disclosure may also keep track of a user's preferences and storage history. In this way, recommendations for other related goods, goods on sale, recipes related to the goods, and the like, can be offered to the user through the user interface. Accessing the user's history and/or user preferences can also facilitate easier access to purchasing or ordering more related goods through the user interface.

Certainly, any or all of these different examples can be combined according to various aspects of the present disclosure, and embodiments are not so limited.

As discussed, a number of non-limiting benefits of aspects of the present disclosure may be apparent. For example, it is not uncommon that a user wishes to cook or bake something in his kitchen, but does not know exactly which ingredients he has available to him and thus does not know completely what he is able to make. As an example, it is not uncommon for a hobbyist baker to store various quantities of baking materials so as to allow the possibility to bake various different kinds of baked goods. However, it is not known what exactly could be made with the various ingredients. A system utilizing the smart containers according to aspects of the present disclosure can be very convenient and informative to the hobbyist baker, or any other person with a similar disposition. In addition, aspects of the present disclosure can help improve safety of various consumable goods or other materials, as well as facilitate better health and habits. Also, aspects of the present disclosure can help save time when trying to go shopping or just trying to carry on with daily life in general. As an example, the user could access the smart containers via a program on his mobile device 100 while at work, determine what food may be available in the house, determine whether he needs to buy more groceries, and if so, determine a convenient route from work to buy his groceries. Other benefits may be apparent to persons of skill in the art, and embodiments are not so limited.

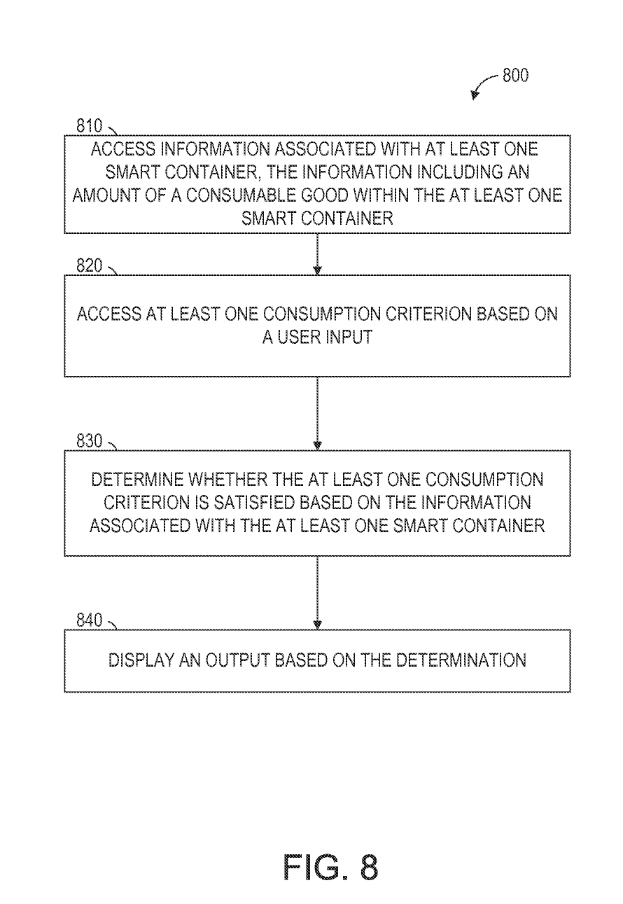

Referring to FIG. 8, the flowchart illustrates an example methodology 800 for accessing inventory using smart containers according to aspects of the present disclosure. The example methodology may be consistent with the methods described herein, including, for example, the descriptions in FIGS. 3, 4, 5, 6 and 7.

At block 810, an example mobile device 100 may access information associated with at least one smart container, the information including an amount of a consumable good within the at least one smart container. Example smart containers may include the descriptions provided herein, for example the smart containers described in FIGS. 3, 4, 5, 6, and 7. The amount of the consumable good included in the information may be expressed in various ways including by weight, by volume, and in any units suitable for describing the amount of the consumable good. Examples of consumable goods can include various types of foods, various sets of ingredients, and the like. Other types of readings or measurements consistent with any of the descriptions of readings or measurements described herein, may also be included in the information described in block 810. The mobile device 100 may include a program or application having a user interface configured to perform the steps described herein, and consistent with the programs or applications described throughout the present disclosures.

At block 820, the mobile device 100 may access at least one consumption criteria based on the user input. The consumption criteria may include various amounts of ingredients, types of recipes, amounts or sizes of types of food, or other consumption constraints consistent with the descriptions throughout the present disclosures. In some cases, the at least one consumption criterion may also include dietary commitments or constraints consistent with those descriptions described herein. In some cases, the user may provide the at least one consumption criterion using an interface on the mobile device 100 and provided by a program or an application according to aspects of the present disclosure.

At block 830, the mobile device 100 may determine whether the at least one consumption criterion is satisfied, based on the information associated with the at least one smart container. Examples of satisfying the consumption criterion may include determining whether the amounts of ingredients in one or more smart containers are sufficient to make a recipe specified by the consumption criterion, determining what recipes could be made with the existing ingredients in the smart containers, determining what ingredients and by what amounts may be needed to satisfy the recipe, and other examples consistent with those described throughout the present disclosures.

At block 840, the mobile device 100 may display an output based on the determination. Example outputs may be consistent with the example responses described in FIGS. 6 and 7. For example, the output may be displayed on a user interface associated with the program or application on mobile device 100. The output may be based on a response to the at least one consumption criterion, and may express whether the consumption criterion is satisfied.

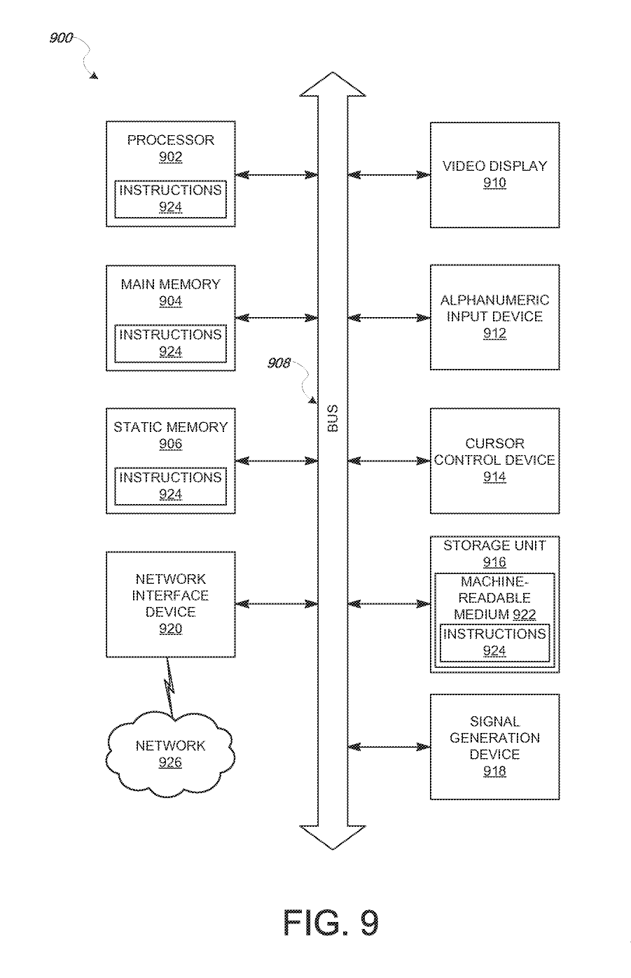

Referring to FIG. 9, the block diagram illustrates components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may include hardware, software, or combinations thereof, and may as examples be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine 900 is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908.

The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a video display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, a signal generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein, including, for example, any of the descriptions of FIGS. 1, 2, 3, 4, 5, 6, 7, and/or 8. The instructions 924 may also reside, completely or at least partially, within the main memory 904, within the processor 902 (e.g., within the processor's cache memory), or both, before or during execution thereof by the machine 900. The instructions 924 may also reside in the static memory 906.

Accordingly, the main memory 904 and the processor 902 may be considered machine-readable media (e.g., tangible and non-transitory machine-readable media). The instructions 924 may be transmitted or received over a network 926 via the network interface device 920. For example, the network interface device 920 may communicate the instructions 924 using any one or more transfer protocols (e.g., hypertext transfer protocol (HTTP)). The machine 900 may also represent example means, or may include a plurality of means for performing any of the functions described herein, including the processes described in FIGS. 1, 2, 3, 4, 5, 6, 7 and/or 8.

In some example embodiments, the machine 900 may be a portable computing device, such as a smart phone or tablet computer, and have one or more additional input components (e.g., sensors or gauges), not shown. Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions 924. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof. The term “machine-readable medium” does not include transitory signals.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

1. A computer implemented method comprising:

accessing information associated with at least one smart container, the information including an amount of a consumable good within the at least one smart container,
accessing at least one consumption criterion based on a user input;
determining whether the at least one consumption criterion is satisfied based on the information associated with the at least one smart container, and
displaying an output based on the determination.

2. The method of description 1, wherein the information includes a plurality of amounts of a plurality of consumable goods within a plurality of containers, and wherein the determining is based further on calculating a recipe based on the plurality of amounts of the plurality of consumable goods.

3. The method of description 1, further comprising measuring or estimating an amount of the consumable good consumed based on the information associated with the at least one smart container, and wherein the determining is based further on calculating a dietary criterion based on the amount consumed.

4. The method of description 1, wherein the at least one consumption criterion includes a recipe including amounts of a plurality of different consumable goods, and the determining is based further on the amounts of the plurality of different consumable goods in the recipe.

5. The method of description 4, wherein the at least one consumption criterion includes a number of portions of the recipe; the method further comprising calculating an updated recipe based on the number of portions; and wherein the determining is based further on the updated recipe.

6. The method of description 1, further comprising, if the output indicates that the criterion is not met, then automatically ordering more of an amount of the consumable good sufficient to satisfy the criterion.

7. The method of description 1, further comprising: accessing a location of the at least one smart container; and determining whether the at least one smart container is safely stored based on the accessed location.

8. The method of description 1, wherein the information further includes health and safety information associated with the consumable good; the method further comprising providing an alert based on the health and safety information associated with the consumable good.

9. The method of description 1, wherein the consumption criterion includes a dietary consumption threshold criterion, and if the output indicates that the dietary consumption threshold criterion has been satisfied, then instructing the at least one smart container to automatically lock the at least one smart container.

10. An apparatus comprising an input interface, an output interface, and at least one processor configured to perform any of the descriptions in descriptions 1 through 9.

11. A computer-readable medium embodying instructions that, when executed by a processor, perform operations comprising any of the descriptions in descriptions 1 through 9.

12. An apparatus comprising means for performing any of the descriptions in descriptions 1 through 9.

What is claimed is:

1. A computer implemented method comprising:
accessing information associated with at least one smart container, the information including an amount of a consumable good within the at least one smart container,
accessing at least one consumption criterion based on a user input;
determining whether the at least one consumption criterion is satisfied based on the information associated with the at least one smart container; and
displaying an output based on the determination.

2. The method of claim 1, wherein the information includes a plurality of amounts of a plurality of consumable goods within a plurality of containers, and
wherein the determining is based further on calculating a recipe based on the plurality of amounts of the plurality of consumable goods.

3. The method of claim 1, further comprising measuring or estimating an amount of the consumable good consumed based on the information associated with the at least one smart container, and
wherein the determining is based further on calculating a dietary criterion based on the amount consumed.

4. The method of claim 1, wherein the at least one consumption criterion includes a recipe including amounts of a plurality of different consumable goods, and the determining is based further on the amounts of the plurality of different consumable goods in the recipe.

5. The method of claim 4, wherein the at least one consumption criterion includes a number of portions of the recipe, the method further comprising:
calculating an updated recipe based on the number of portions; and
wherein the determining is based further on the updated recipe.

6. The method of claim 1, further comprising, if the output indicates that the at least one consumption criterion is not met, then automatically ordering more of an amount of the consumable good sufficient to satisfy the consumption criterion.

7. The method of claim 1, further comprising:
accessing a location of the at least one smart container; and
determining whether the at least one smart container is safely stored based on the accessed location.

8. The method of claim 1, wherein the information further includes health and safety information associated with the consumable good, the method further comprising providing an alert based on the health and safety information associated with the consumable good.

9. The method of claim 1, wherein the at least one consumption criterion includes a dietary consumption threshold criterion, and
if the output indicates that the dietary consumption threshold criterion has been satisfied, then instructing the at least one smart container to automatically lock the at least one smart container.

10. A system comprising:
a memory; and
a processor coupled to the memory and configured to:
access information associated with at least one smart container, the information including an amount of a consumable good within the at least one smart container;
access at least one consumption criterion based on a user input;
determine whether the at least one consumption criterion is satisfied based on the information associated with the at least one smart container; and
display an output based on the determination.

11. The system of claim 10, wherein the information includes a plurality of amounts of a plurality of consumable goods within a plurality of containers, and
wherein the determining is based further on calculating a recipe based on the plurality of amounts of the plurality of consumable goods.

12. The system of claim 10, wherein the processor is further configured to measure or estimate an amount of the consumable good consumed based on the information associated with the at least one smart container, and
wherein the determining is based further on calculating a dietary criterion based on the amount consumed.

13. The system of claim 10, wherein the at least one consumption criterion includes a recipe including amounts of a plurality of different consumable goods, and the determining is based further on the amounts of the plurality of different consumable goods in the recipe.

14. The system of claim 13, wherein the at least one consumption criterion includes a number of portions of the recipe, the processor further configured to:
calculate an updated recipe based on the number of portions; and
wherein the determining is based further on the updated recipe.

15. The system of claim 10, wherein the processor is further configured to automatically order more of an amount of the consumable good sufficient to satisfy the at least one consumption criterion, if the output indicates that the consumption criterion is not met.

16. The system of claim 10, wherein the processor is further configured to:
access a location of the at least one smart container; and
determine whether the at least one smart container is safely stored based on the accessed location.

17. The system of claim 10, wherein the information further includes health and safety information associated with the consumable good, wherein the processor is further configured to provide an alert based on the health and safety information associated with the consumable good.

18. The system of claim 10, wherein the at least one consumption criterion includes a dietary consumption threshold criterion, and
wherein the processor is further configured to instruct the at least one smart container to automatically lock the at least one smart container if the output indicates that the dietary consumption threshold criterion has been satisfied.

19. A computer-readable medium embodying instructions that, when executed by a processor, perform operations comprising:
accessing information associated with at least one smart container, the information including an amount of a consumable good within the at least one smart container;
accessing at least one consumption criterion based on a user input;
determining whether the at least one consumption criterion is satisfied based on the information associated with the at least one smart container; and
displaying an output based on the determination.

20. The computer-readable medium of claim 19, wherein the information includes a plurality of amounts of a plurality of consumable goods within a plurality of containers, and
wherein the determining is based further on calculating a recipe based on the plurality of amounts of the plurality of consumable goods.
